(19) United States
(12) Patent Application Publication
(10) Pub. No.: US 2011/0127821 A1
(43) Pub. Date: Jun. 2, 2011

(54) VEHICLE SEAT AND RECLINER MEMORY MODULE

(75) Inventors: Michael Wojatzki, Ennigerloh (DE); Bernd Hornschuh, Verl (DE); Christian Ruthmann, Herzebrock-Clarholz (DE); Hans-Peter Mischer, Bad Meinberg (DE)

(73) Assignee: LEAR CORPORATION, Southfield, MI (US)

(21) Appl. No.: 12/991,729

(22) PCT Filed: Aug. 15, 2008
(86) PCT No.: PCT/US08/73313

§ 371 Date: Nov. 9, 2010

(51) Int. Cl. B60N 2/20; B60N 2/22; A47C 1/024

(52) U.S. Cl. 297/354.12

(57) ABSTRACT

A seat assembly having a recliner mechanism and a memory module. The recliner mechanism facilitates pivotal movement of a seat back. The memory module controls operation of the recliner mechanism.

### BACKGROUND OF THE INVENTION

1. Field of the Invention

The present invention relates to a vehicle seat and a memory module for a recliner mechanism.

### SUMMARY OF THE INVENTION

In at least one embodiment of the present invention, a seat assembly is provided. The seat assembly includes a recliner mechanism and a memory module. The recliner mechanism is disposed on the seat assembly and facilitates pivotal movement of a seat back. The memory module is disposed on the recliner mechanism and controls operation of the recliner mechanism. The memory module includes a recliner cam that engages the recliner mechanism and a memory lever rotatably disposed on the recliner cam. The memory lever rotates the recliner cam in a first direction to actuate the recliner mechanism to an open condition in which pivotal movement of the seat back is enabled.

In at least one embodiment of the present invention, a vehicle seat assembly is provided. The vehicle seat assembly includes a recliner mechanism and a memory module. The recliner mechanism permits pivotal movement of a seat back when in an open condition and inhibits pivotal movement of the seat back when in a closed condition. The memory module is disposed on the recliner mechanism. The memory module includes a recliner cam that engages the recliner mechanism, a memory lever coaxially disposed with the recliner cam, and a memory hook that selectively engages the memory lever. The recliner mechanism is held in an open position by the recliner cam when the memory hook engages and inhibits rotation of the memory lever.

In at least one embodiment of the present invention, a vehicle seat assembly is provided. The vehicle seat assembly includes a seat back, a seat bottom, a recliner mechanism, and a memory module. The recliner mechanism is fixedly disposed on the seat bottom and includes a pinion. The memory module is disposed on the recliner mechanism. The memory module includes a recliner cam that engages the pinion, a memory lever configured to engage the recliner cam, and a memory hook configured to engage the memory lever. The memory lever inhibits rotation of the recliner cam when the memory hook inhibits rotation of the memory lever.

### BRIEF DESCRIPTION OF THE DRAWINGS

FIG. 1 is a perspective view of a seat assembly.

FIG. 2 is a fragmentary view of the seat assembly and an exploded view of a memory module that may be provided with the vehicle seat.

FIG. 3 is a fragmentary side view of the seat assembly of FIG. 2 with the memory module in a first position.

FIG. 4 is a fragmentary side view of the seat assembly with the memory module in a second position.

FIG. 5 is a fragmentary side view of the seat assembly with the memory module in a third position.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

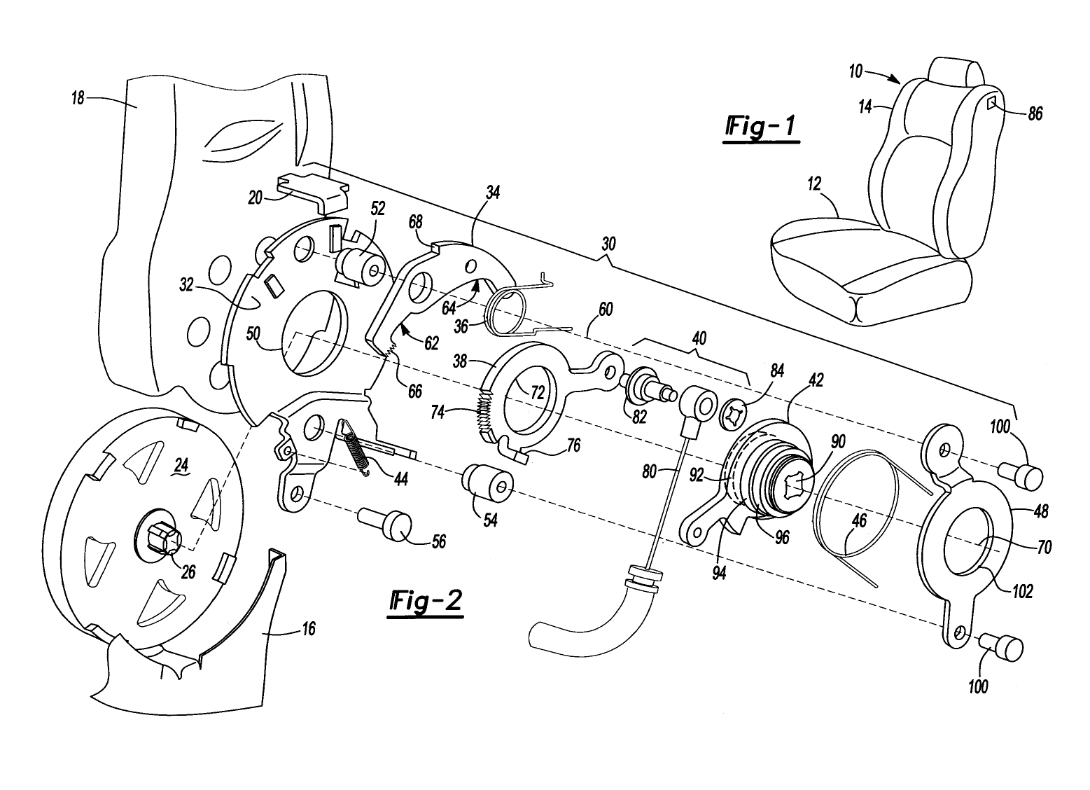

Referring to FIG. 1, an exemplary seat assembly 10 is shown. The seat assembly 10 may be configured for use in a vehicle, such as a motor vehicle like a car or truck.

The seat assembly 10 may include a seat bottom 12 and a seat back 14. The seat bottom 12 may be configured to be mounted on a support surface, such as a floor pan of a vehicle. The seat back 14 may be pivotally disposed on the seat bottom 12 as will be described in more detail below.

Referring to FIG. 2, the seat bottom 12 and seat back 14 may each include structural frames. The frame of the seat bottom 12 may include a seat bottom side member 16. The frame of the seat back 14 may include a seat back side member 18. A trigger 20 may be fixedly disposed on the seat back side member 18. The side members 16, 18 and trigger 20 may be made of any suitable material or materials, such as a metal like an aluminum alloy.

A recliner mechanism 24 may be disposed between the seat bottom side member 16 and the seat back side member 18. The recliner mechanism 24 may be generally disk shaped and may be fixedly positioned with respect to the seat bottom side member 16. For example, the recliner mechanism 24 may be welded to the seat bottom side member 16 and facilitate pivoting of the seat back 14 with respect to the seat bottom 12. The recliner mechanism 24 may be spaced apart from the trigger 20 to allow the seat back 14 to pivot. Moreover, the recliner mechanism 24 may be adapted to permit pivoting of the seat back 14 when in an open condition and inhibit pivoting of the seat back 14 when in a closed condition. The recliner mechanism 24 may include a pinion 26 that may be disposed at or near its center. The pinion 26 may protrude from a side of the recliner mechanism 24 and may be configured to rotate with respect to the housing of the recliner mechanism 24 as will discussed in more detail below.

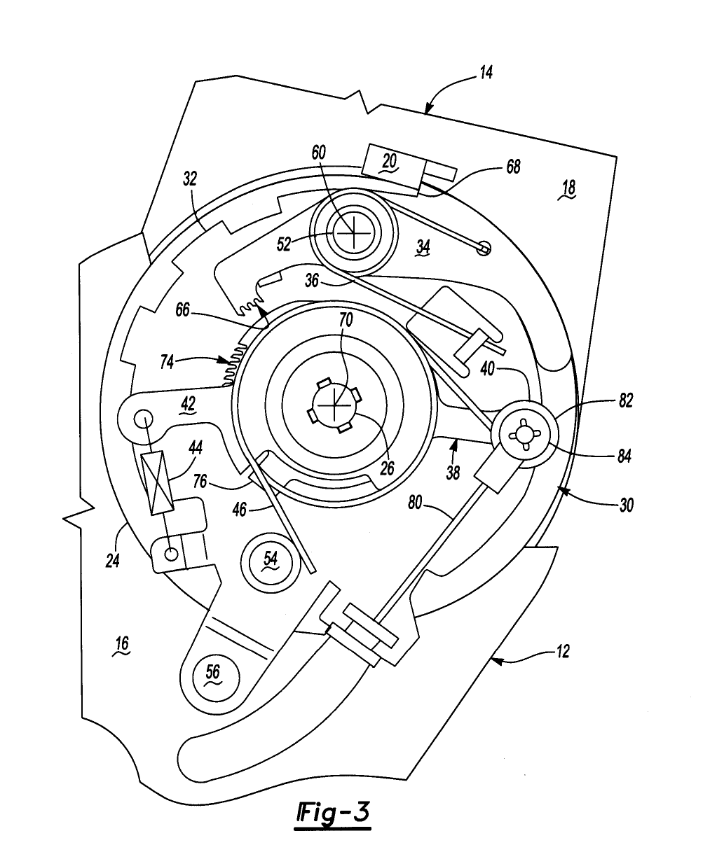

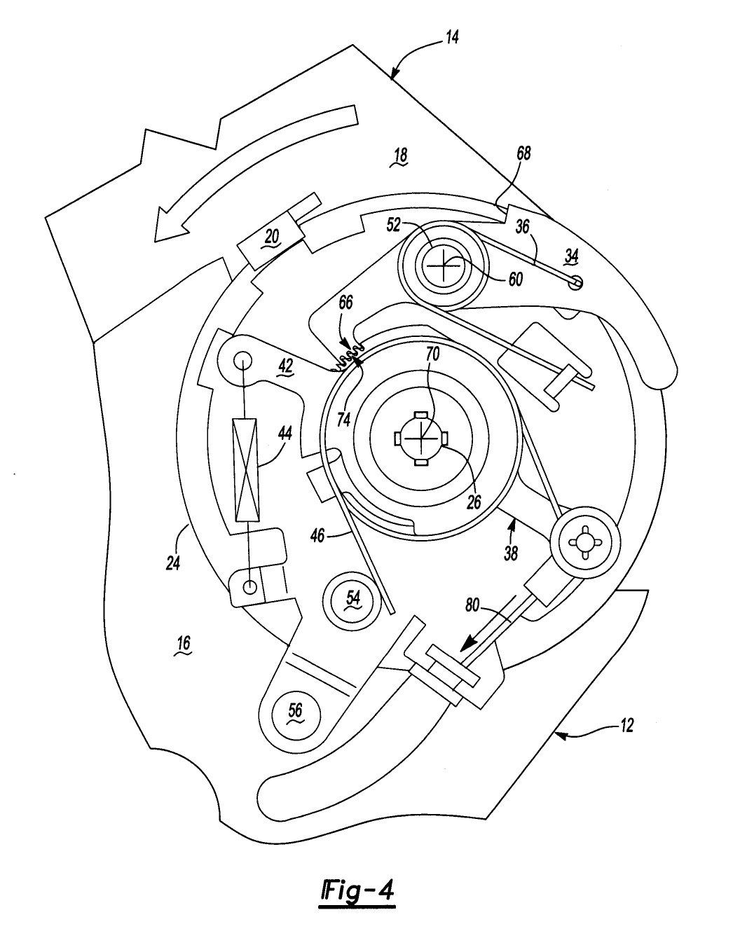

A memory module 30 may be provided that helps control pivoting of the seat back 14 with respect to the seat bottom 12. In at least one embodiment, the memory module 30 may include a base plate 32, a memory hook 34, a memory hook spring 36, a memory lever 38, an actuator assembly 40, a recliner cam 42, a recliner cam spring 44, a memory lever spring 46, and a cover plate 48. Individual components of the memory module 30 are best shown in FIG. 2 while the assembly of the memory module 30 is best shown in FIGS. 3-5.

The base plate 32 may be fixedly disposed on the recliner mechanism 24. The base plate 32 may include various features, such as notches and/or protrusions, that engage mating features on recliner mechanism 24 to facilitate positioning and orientation of the base plate 32 with respect to the recliner mechanism 24. The base plate 32 may include a hole 50 through which the pinion 26 extends. The base plate 32 may include or be configured to receive a first mounting pin 52, a second mounting pin 54, and a mounting bolt 56. The first and second mounting pins 52, 54 may be spaced apart from each other and may extend substantially parallel to the pinion 26. The mounting pins 52, 54 may have any suitable configuration and may be configured as fasteners, such as bolts. The mounting bolt 56 may extend through an opening in the base plate 32 and attach the base plate 32 to the seat bottom side member 16.

The memory hook 34 may be pivotally disposed on the first mounting pin 52 and may rotate about an axis of rotation 60 represented by the associated dashed line in FIG. 2. The memory hook 34 may have any suitable configuration. For example, the memory hook 34 may include a first arm portion 62 and a second arm portion 64. The first arm portion 62 may include one or more engagement features 66 that may be adapted to inhibit rotation of the memory lever 38. The engagement features 66 may be configured as one or more teeth as shown in FIG. 2. Optionally, the engagement features 66 may be configured as a hook, tab, or other feature in one or more embodiments of the present invention. The memory hook 34 may also include a trigger engagement feature 68 that may cooperate with the trigger 20 to control operation of the memory module 30 as will be discussed in more detail below.

The memory hook spring 36 may be configured to exert a biasing force on the memory hook 34. The memory hook spring 36 may have any suitable configuration. In the embodiment shown, the memory hook spring 36 includes a coil portion that is disposed around the first mounting pin 52, a first end that engages the memory hook 34, and a second end that may engage the base plate 32. As such, the memory hook spring 36 may exert a biasing force against the second arm portion 64 to rotate the memory hook 34 in a counterclockwise direction to move the first arm portion 62 and engagement features 66 toward the memory lever 38 in the absence of a sufficient counteracting force. The memory hook spring 36 may be provided in other configurations and does not necessarily have to be disposed about the first mounting pin 52 in one or more embodiments of the present invention.

The memory lever 38 may be configured to rotate about a center axis of rotation 70. The memory lever 38 may include a hole 72 through which the pinion 26 extends. In addition, the memory lever 38 may include one or more engagement features 74 that are compatible with the engagement features 66 on the memory hook 34. In the embodiment shown, the engagement features 74 are configured as a set of teeth. Optionally, the engagement features 74 may be configured as a hook, tab, protrusion, or other feature in one or more embodiments of the present invention. The memory lever 38 may include a rotation tab 76 that may engage and rotate the recliner cam 42 as will be discussed in more detail below.

The actuator assembly 40 may be configured to actuate the memory lever 38. The actuator assembly 40 may have any suitable configuration. In the embodiment shown in FIG. 2, the actuator assembly 40 includes a cable 80, such as a Bowden cable, that may be connected or coupled to the memory lever 38. For example, a first end of the cable 80 may be attached to a fastener 82, such as a pin, and retained by a nut 84. The fastener 82 may extend from the memory lever 38 and may be provided as a separate component or may be integrally formed with the memory lever 38. If the fastener 82 is provided as a separate component, it may be attached in any suitable manner, such as with a fastener like a rivet, welding, adhesive, or an interference fit. The cable 80 may have a second end (not shown) that is disposed opposite the first end and is attached to a handle 86 (shown in FIG. 1) that may facilitate manual operation or activation of the seat assembly 10. For instance, the handle 86 may be mounted on a portion of the seat, such as the seat bottom 12 or seat back 14, and may be actuated by a user to initiate pivotal movement of the seat back 14 as will be discussed in more detail below.

The recliner cam 42 may be configured to receive the pinion 26 and to rotate about the center axis of rotation 70. For example, the recliner cam 42 may include a socket-like hole 90 that mates with the pinion 26 in one or more embodiments of the present invention. The recliner cam 42 may include a first hub 92 that extends from a back side of the recliner cam 42 and into the center hole 72 of the memory lever 38 to help align the memory lever 38 and recliner cam 42 and provide a bearing surface upon which the memory lever 38 may rotate. The recliner cam 42 may also include a second hub 94 extending from a front side of the recliner cam 42 and a third hub 96 extending from the second hub 94. The first, second, and third hubs 92, 94, 96 may be generally cylindrical and may be concentrically disposed about the center axis of rotation 70.

The recliner cam spring 44 may exert a biasing force against the recliner cam 42. The recliner cam spring 44 may have any suitable configuration. In the embodiment shown, the recliner cam spring 44 has a helical configuration and includes a first end that engages the base plate 32 and a second end that engages the recliner cam 42. In FIG. 2, the biasing force of the recliner cam spring 44 pulls the recliner cam 42 in a counterclockwise direction. The recliner cam spring 44 may be provided in other configurations in one or more embodiments of the present invention.

The memory lever spring 46 may be configured to exert a biasing force on the memory lever 38. The memory lever spring 46 may have any suitable configuration. In the embodiment shown, the memory lever spring 46 includes a coil portion that may be generally disposed around the second hub 94, a first end that engages part of the actuator assembly 40, such as fastener 82, and a second end that engages the second mounting pin 54. The first end may be retained between the memory lever 38 and an enlarged portion of the fastener 82 in one or more embodiments of the present invention. Alternatively, the first end may directly engage the memory lever 38 and the second end may be disposed directly against a tab or mating feature on the base plate 32 or other fixed surface in one or more embodiments of the present invention. In FIG. 2, the biasing force of the memory lever spring 46 may rotate the memory lever 38 in a counterclockwise direction about the center axis of rotation 70 and may be sufficient to actuate or retract the cable 80 when sufficient counteracting force is not being applied to the cable 80. In addition, the memory lever spring 46 may help inhibit rattling of the memory lever 38 against the recliner cam 42. The memory lever spring 46 may be provided in other configurations and does not necessarily have to be disposed about the second hub 94 in one or more embodiments of the present invention.

The cover plate 48 may be provided to help retain the components of the memory module 30. The cover plate 48 may be mounted in a fixed position relative to the base plate 32. For example, one or more fasteners 100 may be used to couple the cover plate 48 to the mounting plate 32 or features that are stationary with respect to the base plate 32, such as the first and second mounting pins 52, 54. The cover plate 48 may include an opening 102 that receives a hub, such as the third hub 96, and permits rotation of the recliner cam 42.

Referring to FIGS. 3-5, operation of the memory module 30 is illustrated in more detail. In these figures the cover plate 48 is not shown for clarity.

In FIG. 3, the seat back 14 is shown in a first position or standard seating position in which the seat back 14 is disposed at an obtuse angle or tilted back from the seat bottom 12. In this position, the recliner mechanism 24 may inhibit pivoting of the seat back 14 with respect to the seat bottom.

In the position shown in FIG. 3, the memory module 30 is shown with the trigger 20 in engagement with the trigger engagement feature 68 on the memory hook 34. The force exerted by the trigger 20 overcomes the biasing force exerted by the memory hook spring 36. As a result, the engagement features 66 on the memory hook 34 are spaced apart and disengaged from the engagement features 74 on the memory lever 38. The memory lever 38 is then free to rotate and is biased in a counterclockwise direction by the memory lever spring 46, which moves the actuator assembly 40 and its cable 80 to a retracted position. The counterclockwise rotation or positioning of the memory lever 38 and its rotation tab 76 allows the recliner cam 42 to also rotate in a counterclockwise direction due to the biasing force exerted by the recliner cam spring 44.

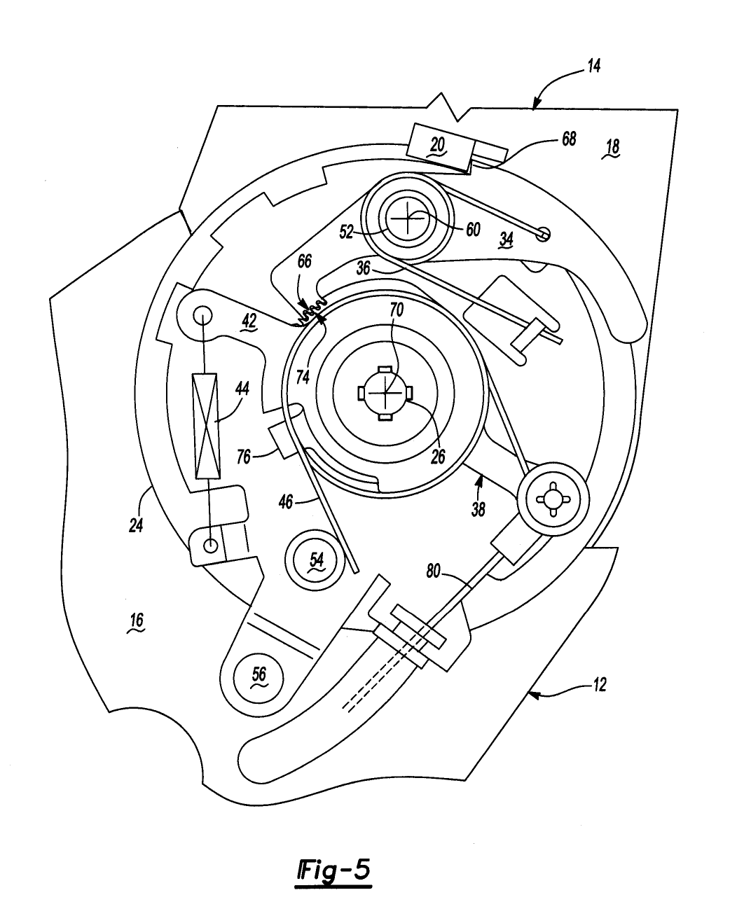

In FIG. 4, the seat back 14 is shown in a second position after the seat back 14 is actuated forward or toward the seat bottom 12. This position may be referred to as the “easy entry” position in which the seat back 14 is positioned to provide additional space for entry into a rear seating area, such as may be provided in a vehicle without rear doors.

Movement from the standard seating position shown in FIG. 3 toward the easy entry position in FIG. 4 may be initiated when a user actuates the handle 86. If sufficient force is exerted with the handle 86 to overcome the biasing force exerted by the memory lever spring 46, then the cable 80 is actuated in the direction represented by the straight arrow and the memory lever 38 is rotated in a clockwise direction to the position shown in FIG. 4. Rotation of the memory lever 38 causes the rotation tab 76 to engage the recliner cam 42. The force exerted by the rotation tab 76 on the recliner cam 42 may overcome the biasing force of the recliner cam spring 44, causing the recliner cam 42 to rotate in a clockwise direction toward the position shown in FIG. 4. Folding of the seat back 14 toward the seat bottom 12, which may be accomplished at least in part by force exerted by the user, disengages the trigger 20 from the trigger engagement feature 68, which allows the memory hook 34 to rotate in a clockwise direction due to the biasing force exerted by the memory lever spring 36. As such, the engagement features 66 on the memory hook 34 may engage the engagement features 74 on the memory lever 38. As such, the pinion 26 may rotate and the recliner mechanism 24 may be moved to and held in an open position by the recliner cam 42.

In FIG. 5, the seat back 14 is shown in a third position after it is reclined away from the folded position shown in FIG. 4 and just before returning to the first position shown in FIG. 3.

In the third position, the trigger 20 is shown just prior to actuating the memory hook 34. The trigger 20 actuate the memory hook 34 by exerting sufficient force on the trigger engagement feature 68 to overcome the biasing force of the memory hook spring 36 and rotate the memory hook 34 clockwise, which disengages the engagement features 66, 74. Disengagement of the engagement features 66, 74 allows the memory lever 38 to rotate counterclockwise due to the biasing force of the memory lever spring 46 and back to the position shown in FIG. 3. In addition, the counterclockwise rotation of the memory lever 38 and its rotation tab 76 permits the recliner cam 42 to rotate in a counterclockwise direction.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A seat assembly comprising:
a recliner mechanism disposed on the seat assembly that facilitates pivotal movement of a seat back; and
a memory module disposed on the recliner mechanism and controls operation of the recliner mechanism, the memory module including:
a recliner cam that engages the recliner mechanism, and
a memory lever rotatably disposed on the recliner cam;
wherein the memory lever rotates the recliner cam in a first direction to actuate the recliner mechanism to an open condition in which pivotal movement of the seat back is enabled.

2. The seat assembly of claim 1 wherein the recliner cam rotates in a second direction disposed opposite the first direction to a closed position in which pivotal movement of the seat back is inhibited when the memory module is rotated in the second direction.

3. The seat assembly of claim 1 further comprising a memory hook that inhibits rotation of the memory lever when the seat back is pivoted toward a seat bottom.

4. The seat assembly of claim 3 wherein the seat back includes a trigger that rotates and disengages the memory hook from the recliner cam when the seat back is disposed in a seating position in which the seat back is disposed at an obtuse angle relative to the seat bottom.

5. The seat assembly of claim 1 wherein the recliner cam and the memory lever rotate about a common axis of rotation.

6. The seat assembly of claim 1 further comprising a cable coupled to the memory lever that rotates the memory lever in the first direction when sufficient force is applied to the cable.

7. The seat assembly of claim 1 further comprising a recliner cam spring that exerts a biasing force on the recliner cam for rotating the recliner cam in a second direction disposed opposite the first direction.

8. The seat assembly of claim 1 further comprising a memory lever spring that exerts a biasing force for rotating the memory lever in a second direction disposed opposite the first direction.

9. The seat assembly of claim 1 further comprising a memory hook spring that exerts a biasing force for rotating the memory hook into engagement with the memory lever.

10. A vehicle seat assembly comprising:
a recliner mechanism that permits pivotal movement of a seat back when in an open condition and inhibits pivotal movement of the seat back when in a closed condition; and
a memory module disposed on the recliner mechanism, the memory module including:
a recliner cam that engages the recliner mechanism,
a memory lever coaxially disposed with the recliner cam, and
a memory hook that selectively engages the memory lever;
wherein the recliner mechanism is held in an open position by the recliner cam when the memory hook engages and inhibits rotation of the memory lever.

11. The vehicle seat of claim 10 wherein the memory lever engages the memory hook when the seat back is pivoted toward a seat bottom.

12. The vehicle seat of claim 10 wherein the recliner cam and memory lever rotate about a first axis of rotation and the memory hook rotates about a second axis of rotation spaced apart from the first axis of rotation.

13. The vehicle seat of claim 10 wherein a pinion of the recliner mechanism extends through the memory lever.

14. The vehicle seat of claim 10 further comprising a base plate disposed on the recliner mechanism and a cover plate fixedly mounted to the base plate, wherein the cover plate receives a portion of the recliner cam and the recliner cam receives the memory lever.

15. The vehicle seat of claim 10 wherein the memory lever includes a rotation tab that engages and rotates the recliner cam when the memory lever is rotated by an actuator assembly.

16. A vehicle seat assembly comprising:
a seat back;
a seat bottom;
a recliner mechanism fixedly disposed on the seat bottom and including a pinion; and
a memory module disposed on the recliner mechanism, the memory module including:
a recliner cam that engages the pinion,
a memory lever configured to engage the recliner cam, and
a memory hook configured to engage the memory lever;
wherein the memory lever inhibits rotation of the recliner cam when the memory hook inhibits rotation of the memory lever.

17. The vehicle seat assembly of claim 16 wherein the memory hook inhibits rotation of the memory lever when the memory hook is spaced apart from a trigger disposed on the seat back.

18. The vehicle seat assembly of claim 16 wherein the memory lever is configured to rotate on the recliner cam.

19. The vehicle seat assembly of claim 16 further comprising an actuator mechanism that rotates the memory lever in a first direction and a memory lever spring that rotates the memory lever in a second direction disposed opposite the first direction.

20. The vehicle seat assembly of claim 16 further comprising a memory hook spring and a recliner cam spring that engage the memory hook and recliner cam, respectively, to bias the memory hook and recliner cam to rotate in a common rotational direction.
